(19) United States
(12) Patent Application Publication
(10) Pub. No.: US 2017/0120461 A1
(43) Pub. Date: May 4, 2017

(54) FOLDING ASSEMBLIES WITH LOCKING AND OPEN AND CLOSE ASSIST MECHANISMS

(71) Applicant: FirstEdge, Inc., Vista, CA (US)

(72) Inventors: Wesley James Tom, Vista, CA (US); Brett Philip Seber, Vista, CA (US)

(73) Assignee: FirstEdge, Inc., Vista, CA (US)

(21) Appl. No.: 15/406,943

(22) Filed: Jan. 16, 2017

Related U.S. Application Data
(63) Continuation-in-part of application No. 15/000,669, filed on Jan. 19, 2016, now Pat. No. 9,483,120.
(60) Provisional application No. 62/279,949, filed on Jan. 18, 2016.
(60) Provisional application No. 62/105,606, filed on Jan. 20, 2015.

(51) Int. Cl. B26B 1/04

(52) U.S. Cl. CPC B26B 1/048; B26B 1/044

(57) ABSTRACT

A folding assembly having first and second members that are pivotally attached to one another. A locking pin is disposed through the first member and second member and selectively actuatable to unlock the pivoting and opening or closing of the first and second members relative to one another. A spring-assist mechanism includes a primary spring element and a secondary spring element which act in conjunction to successively apply an opening force to the first or second member as it is opened. The assembly also includes a close-assist mechanism for partially closing the first and second members relative to one another.

### RELATED APPLICATIONS

This application claims priority from U.S. Provisional Application Ser. No. 62/279,949, filed Jan. 18, 2016, and is a Continuation-in-Part of U.S. application Ser. No. 15/000,699 filed Jan. 19, 2016, which claims priority from U.S. Provisional Application Ser. No. 62/105,606, filed Jan. 20, 2015.

### BACKGROUND OF THE INVENTION

The present invention generally relates to folding assemblies, such as foldable knives and hand tools. More particularly, the present invention relates to folding assemblies having one member that is pivotably attached to another member, and that incorporates a locking mechanism therein for purpose of fixing the location of one member relative to the other, e.g., in an open and/or closed position, as well as an open-assist mechanism for assisting in the opening of one member relative to the other.

Folding assemblies incorporating locking mechanisms are known in the art. An example of such folding assemblies are folding knives having one member in the form of a blade that is pivotably attached to another member in the form of a handle, and that may be manually operated to move the blade from a closed position disposed within the handle for storage to an open position exposed from the handle force. Such known folding assemblies in the form of folding knives include a locking mechanism to keep the blade member in an open locked position during use. The conventional locking mechanism used in such folding knives is provided in one of two forms, that of a linerlock gate system or lockback rocker system.

The linerlock gate system is one that makes use of a biased gate member that is disposed within the knife between the handles and that extends generally parallel with the handles. As the knife is unfolded from its closed position within the handle to a position approaching an opened position the gate member snaps by bias force into place against a backside edge or butt of the knife to lock the blade member into an opened position. The blade member is released from its locked open position by manually urging the gate member away from engagement of the blade member backside edge.

A shortcoming of such linerlock gate system is that the locked engagement between the blade backside edge and the gate member may become disengaged during use of the knife in situations where the blade has too much force applied in the wrong direction causing the blade member to bend relative to the handles. Such bending of the blade member is known to cause the gate member to disengage the blade member, unintentionally causing the blade member to become unlocked, which can both present an unsafe situation for the user and/or render the knife unusable.

The lockback rocker system is one that makes use of a biased rocker element that is disposed within the knife between the handles along a top surface of the knife generally parallel with the handles. As a user extends the knife member from its closed position disposed within the handles to an open position, a backside edge of the blade member slides long the biased rocker element causing the rocker element to move upwardly until the blade member is moved to the open position where the rocker element registers with a surface portion of the knife blade to lock the knife blade into the open position. The blade member is released from its locked position by manually pressing on a rear section of the rocker element to raise a front section of the rocker element to disengage it with the surface section of the blade member.

A shortcoming of such lockback rocker system is that the locked engagement between the blade surface portion and the rocker member may become disengaged during use of the knife. This can occur, for example, in situations where the rear section of the rocker element is contacted by an object during use, such as, to assist in a cutting activity or the like, unintentionally causing the blade member to become unlocked, which can both present an unsafe situation for the user and/or render the knife unusable.

In such conventional knives, two hands are necessary in order to close the knife safely. Alternatively, at times users will hold the handle with one hand and press the unsharpened top blade edge against another object, such as their leg, in order to attempt to close the knife. Obviously, this can be a safety issue as user can inadvertently cut or stab himself or damage the knife blade when attempting to close it with a single hand and another object instead of two hands.

Folding knives and handheld tools typically require the user to grasp a portion of the blade or tool to be unfolded from the handle portion and exert manual force in order to pivot the blade or tool away from the handle. In some cases, such as when the knife or tool is new, not properly oiled, etc. a significant amount of manual force must be applied in order to unfold the blade or tool from the handle. There do exist, however, spring-system mechanisms for fully opening a blade from a handle, such as a switchblade. In such fully-assisted knives, the blade opens very rapidly from the handle which can be unsafe for the untrained user thereof. In fact, most jurisdictions in the United States deem the ownership and/or use of such fully-assisted knives to be illegal for those other than military and police personnel.

It is, therefore, desired that a folding assembly comprising two members pivotably attached to one another be constructed in a manner having an improved locking mechanism that reduces or eliminates situations where during use one of the members becomes unintentionally unlocked, thereby extending the safety and reliability of the folding assembly during use, and extending the service life of the folding assembly. It is also desired that folding assemblies comprise assisted activation of the one member from a closed to an open position, or vice versa, relative to the other member in a manner that is relatively easy to operate, safe and reliable. The present invention fulfills these needs, and provides other related advantages.

### SUMMARY OF THE INVENTION

The present invention generally relates to folding assemblies having one member, such as a handle, that is pivotally attached to another member, such as a knife blade or other tool. The folding assembly incorporates a locking mechanism for fixing the location of the members relative to one another. The locking mechanism of the present invention reduces or eliminates situations where during use one of the members becomes unintentionally unlocked. The folding assemblies herein also include open-assist and close-assist mechanisms for facilitating the opening and/or closing of the tool with respect to the handle, such that the folding assemblies relatively easy and safe to operate.

A folding assembly in accordance with the present invention generally comprises a tool pivotally connected to a handle and movable between a closed position in which the tool extends along the handle and an open position which a free end of the tool extends away from the handle. The folding assembly may comprise a folding knife, with the tool comprising a blade, although other hand tools and folding assemblies are contemplated by the present invention.

A manually actuated locking pin extends axially through an elongated slot formed in the tool and into a track of the handle. A portion of the locking pin travels a length of the track as the tool is moved between the closed and open positions.

The handle may comprise first and second grips and first and second liners disposed between the grips and spaced relation on opposite sides of the tool when in the closed position.

The track is formed in the handle, typically in at least one of the first and second grips and at least one of the first and second liners. The track is formed in the handle radially from a pivotal connection point of the tool and the handle so as to define a first locked region and a second locked region spaced from the first locked region. The locking pin locks the tool in the closed position when in the first locked region of the track, and locks the tool in the open position when in the second locked region of the track.

A spring is disposed within the elongated slot of the tool for biasing the locking pin away from the free end of the tool. The spring may comprise a compression spring disposed within the slot generally transverse to the locking pin. A guide pin may be disposed within the slot and compression spring.

The folding assembly includes a mechanism for assisting in the closing of the tool, comprising slide that is disposed within an external recess of the handle and manually movable to engage and move the locking pin from the first locked region of the track, partially moving the tool toward the closed position. The slide is biased away from the locking pin.

The folding assembly also includes a mechanism for assisting in the opening of the tool comprising at least one spring extending between the tool and handle which exerts an opening force to the tool once the tool has been manually moved a distance along its opening path. The open assisting mechanism comprises a first spring and a second spring disposed within the handle that cooperatively assist in moving the tool to an open position. The first spring exerts a first force to the tool. The second spring exerts a second force to the tool which may be greater than the first force. The first spring exerts an opening force a first range of the opening path of the tool and the second spring exerts an opening force along at least a second range of the opening path of the tool. The first spring typically comprises a wire form spring extending between the tool and handle. The second spring comprises a compression spring which at least partially surrounds the first spring.

Other features and advantages of the present invention will become apparent from the following more detailed description, taking conjunction with the accompanying drawings, which illustrated, by way of the example, the principle of the invention.

### BRIEF DESCRIPTION OF THE DRAWINGS

The accompanying drawings illustrate the invention. In such drawings:

FIG. 1 is a side perspective view illustrating a folding assembly embodied in the form of a folding knife in an open position;

FIG. 2 is a side elevational view of the folding knife of the present invention in a closed position;

FIG. 3 is a top side exploded view illustrating the folding knife;

FIG. 4 is an underside exploded view illustrating the folding knife;

FIG. 5 is another exploded view illustrating the folding knife;

FIG. 6 is a sectional diagrammatic view illustrating a spring and guide pin in an elongate opening through a blade member of the folding knife in engagement with a locking pin, in accordance with the present invention;

FIG. 7 is a sectional diagrammatic view illustrating the locking pin of FIG. 6 disposed within a locking region of a track formed in the handle;

FIG. 8 is a sectional diagrammatic view similar to FIG. 7, illustrating the locking pin moved into another locking region of the track;

FIG. 9 is a partially sectioned diagrammatic view illustrating a slide disposed within an external recess of the handle and the locking pin in a first locked region of the track;

FIG. 10 is a sectional diagrammatic view similar to FIG. 9, but illustrating the slide moved into a contact with the locking pin so as to move the locking pin from the first lock region of the track and partially moving a blade of the assembly towards a closed position;

FIG. 11 is a side and sectional view of a folding knife embodying the present invention, illustrating a spring-assist mechanism used in accordance with the present invention;

FIG. 12 is a side sectional view similar to FIG. 11, but illustrating the opening of the blade of the knife; and

FIG. 13 is a side and sectional view of the folding knife of the present invention, illustrating the blade mechanism in a fully extended position, and the assist mechanism in a relaxed state, in accordance with the present invention.

### DETAILED DESCRIPTION OF THE PREFERRED EMBODIMENTS

As shown in the accompanying drawings, for purposes of illustration, the present invention resides in folding assemblies, such as foldable knives and hand tools, having locking and open-assist and closed-assist mechanisms. Generally, the folding assemblies as disclosed herein comprise first and second members that are pivotably attached to one another and include an improved locking, open and closed assist mechanisms when contrasted to conventional folding assemblies with locking mechanisms such as those described above known in the art.

More specifically, folding assemblies as disclosed herein comprise a first member that is pivotably attached to a second member, wherein the first member is interposed between a pair of liners that are part of the second member. Each of the liners are specially configured to accommodate and enable rotational movement of a locking pin disposed through a portion of the first member as the first member is rotated between one position, e.g., a closed position, and another position, e.g., an open position, relative to the second member and liners. Each of the liners is further configured to accommodate placement of a stop element or pin therein. The locking pin is thus disposed through the first member and is placed in double shear by fitment at opposed end through a respective liner to thereby ensure a robust and maintained locked engagement of the first member relative to the second member. The stop element operates to restrict travel of the first member of the first blade member beyond that permitted by cooperation of the locking pin member with a specific section of the liners. Moreover, a double spring assist mechanism sequentially assists the user in opening the first member relative to the second member. Furthermore, a close-assist mechanism assists the user in closing the first member relative to the second member.

Folding assemblies as disclosed herein comprise first members that may be configured differently to perform a variety of different functions depending on the particular end-use application, while the second member may be configured to hold the folding assembly stationary relative to the first member during and/or after rotational pivoting movement of the first folding member relative to the second member. Nonlimiting examples of first member or tool configurations may be in the form of a knife blade, saw blade, tool blade or element, and the like. In an example, the folding assemblies and locking mechanisms as disclosed herein may be configured to enable movement, e.g., opening, of the first member relative to the second member by manual means, e.g., by a user manually engaging a portion of the first member knife and pivotably moving it relative to the second member. In an example, the folding assemblies as disclosed herein may be configured to provide assisted movement of the first member, e.g., by a user engaging a release element of the locking mechanism, to thereby enable the first member to move from a closed position to an open position. Further details regarding such folding assemblies as disclosed herein and their constructions are provided below with reference to certain example embodiments.

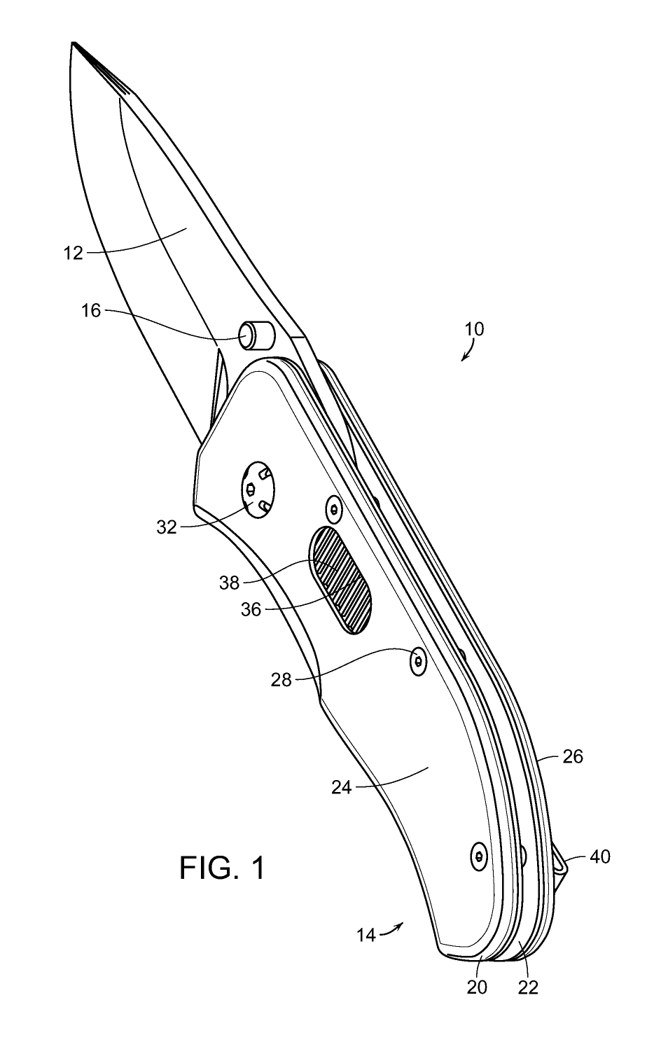

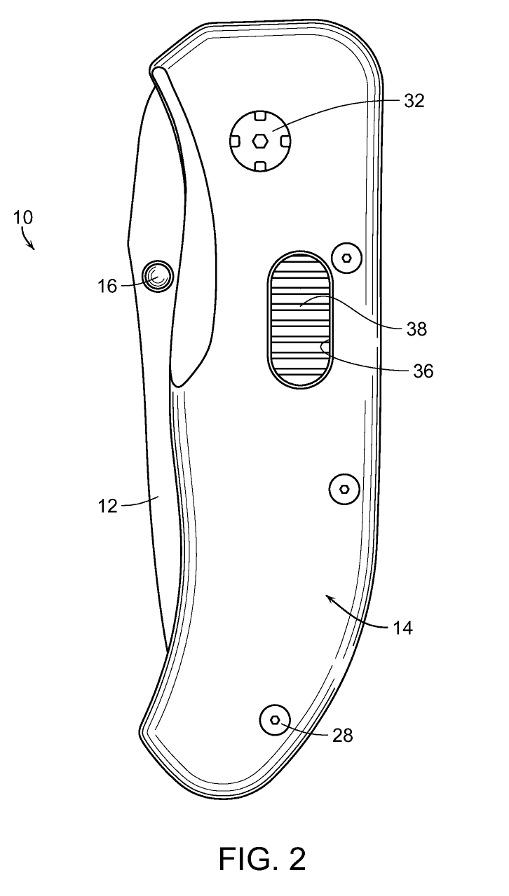

FIGS. 1 and 2 illustrate an example folding assembly in the form of a folding knife 10. Such embodiments of folding assemblies and locking and open-assist and close-assist mechanisms as disclosed herein are provided for purpose of reference for describing and illustrating the components and function of such folding assemblies and mechanisms, and it is to be understood that folding assemblies and mechanisms as disclosed herein may be embodied in a variety of different embodiments which all embody the principles of the concept and are within the scope of the concept as disposed herein.

With reference to the embodiment illustrated in FIG. 1, the folding knife 10 generally comprises a first member or tool in the form of a blade 12 (shown in an open position) that is pivotably rotatably attached with a second member in the form of a housing or handle 14. The folding knife 10 is configured for manual movement of the blade 14 from an open position, as shown in FIG. 1 to a closed position, as illustrated in FIG. 2, and vice versa. Such manual movement can be achieved by a user's contact with a thumb stud 16 disposed through or into the blade 12 and located near a top portion of the blade, e.g., away from the sharpened edge. The folding knife 10 is configured for assisted movement of the blade 12 between closed and open positions. Such assisted movement can be achieved through the use of an assist mechanism comprising an assist element, such as springs or the like, disposed within the knife (as described in greater detail below).

With reference to FIG. 1, the folding knife 10 is shown in an opened position comprising the blade 12 and the handle 14. The handle 14 comprises a pair of liners 20 and 22 that are part of the locking and open-assist and close-assist mechanisms and that are positioned on opposite surfaces of the blade 12, sandwiching the blade 12 therebetween. Grips 24 and 26 are attached to an outer surface of each respective liner and may have an outer surface that is smooth, textured or otherwise configured to meet the needs of a particular end-use application. In an example, the grips have an outside surface that is textured to provide a desired degree of slip resistance during use. The grips and liners are attached to one another through the use of fastening elements 28, such as by screws, rivets or the like that may extend through openings 30 that exist through the grips and liners.

Spacers 31 are interposed between the liners 20 and 22 and receive fasteners 28 therein. The spacers 31 operate to provide the desired distance or spacing between the liners 20 and 22 that is sufficient to enable the unbinding movement of the blade member 12 when pivoted between closed and open positions. In the illustrated example, the folding knife 10 comprises three spacers 31 that are each made from structurally rigid material. Typically, the spacers are round and having axial thickness slightly greater than that of the blade 12. Each has an opening extending axially therethrough that is threaded to accommodate the mounting screws 28 therein. The mounting screws 28 may have a hex head or other configuration for insertion and tightening to the handle 14. In the illustrated example, a total of six mounting screws 28 are used, wherein three are used to attach grip 24 and liner 20 via the spacers 31 and the other three are used on the opposite surface of the handle 14 to attach the grip 26 and liner 22 via the spacers 31.

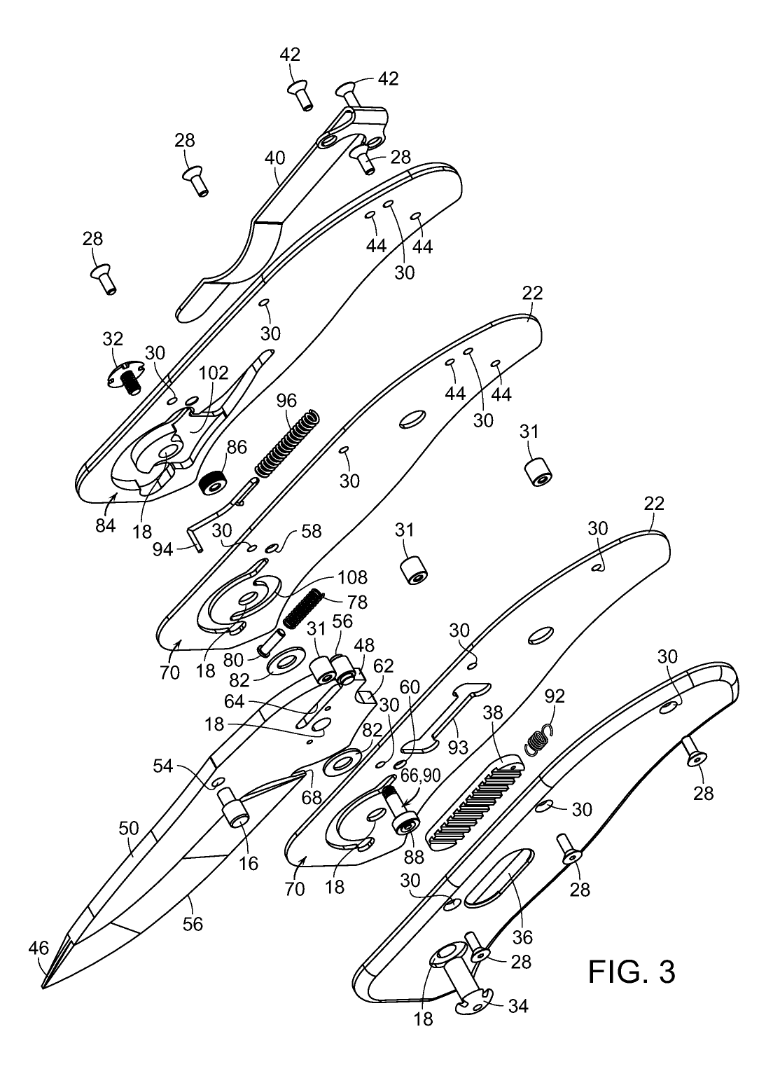

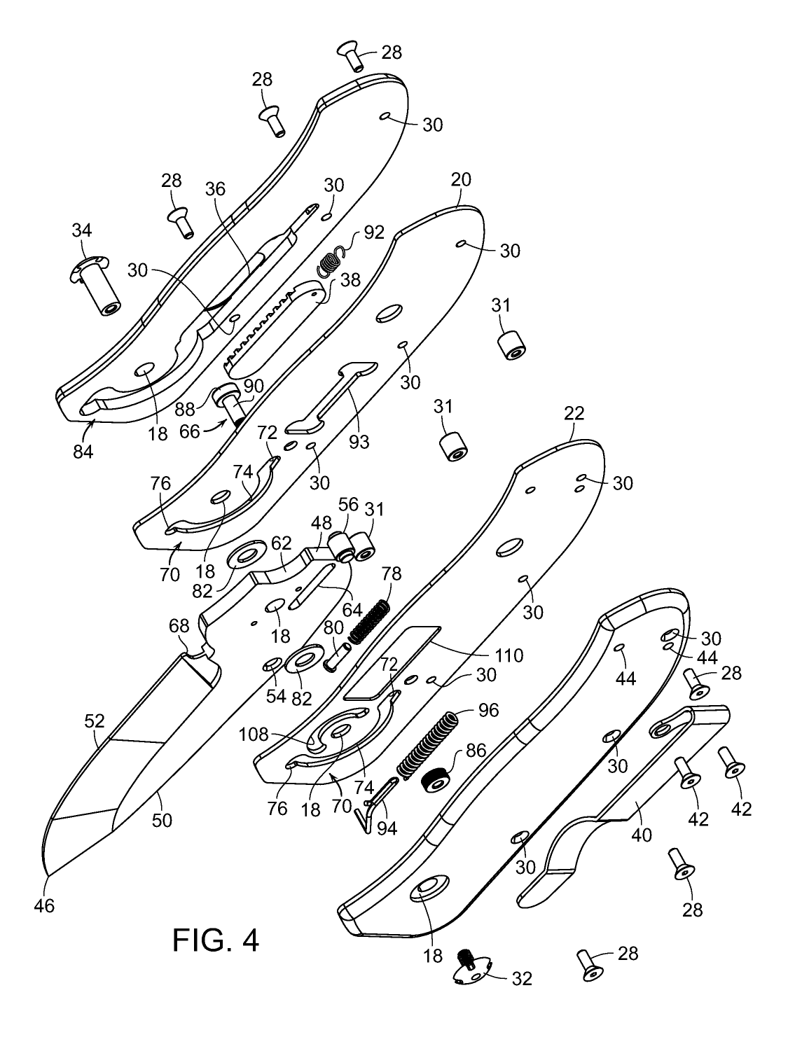

A main or pivot pin 32 is disposed axially through the handle 14 and the blade 12 and operates to connect the blade to the housing and permit pivoting rotatable movement of the blade relative to the housing. The main pivot pin 32 may include a mating element 34 on the opposite side of the knife that registers with the pin 32 to facilitate a fastened, e.g., threaded or otherwise, attachment therebetween. The pivot pin 32 extends through apertures 18 which are aligned in the grips 24 and 26, liners 20 and 22 and blade 12, as illustrated in FIGS. 3-5. Mating element 34 may also extend into one or more of the aligned pivot point apertures 18 so as to engage pivot pin or screw 32.

With reference again to FIGS. 1 and 2, the handle 14 includes an open-faced, external recess 36, such as in grip 24, which provides access to the user to slide 36 which forms part of a close-assist mechanism used in accordance with the present invention, and as will be described more fully herein. The recessed area 36 allows the slide 38 to be easily accessible to the user, such as a thumb of the user to actuate the slide 38, while avoiding unintentional contact and/or activation of the slide 38. As illustrated, the slide 38 preferably has an uneven or textured surface so as to provide grip to the thumb or finger of the use so as to facilitate the actuation thereof.

The folding assembly, as disclosed and illustrated herein as a folding knife 10, may comprise an optional attachment clip 40 for purposes of wearing or carrying the knife. In an example, such an attachment clip 40 may be attached to the knife by one or more fasteners 42 that extend through openings 44 in the handle 14, such as through grip 26 and liner 22.

FIGS. 3-5 illustrate the knife 10 as disclosed herein in an exploded or disassembled state showing the various elements and members used to construct the folding knife 10. The blade 12 is typically made from a metallic material, and in a preferred example is made from hardened metal, an alloy metal such as stainless steel or the like, and combinations thereof. In an example, the blade is made from Elmax and has a Rockwell C Hardness (HRC) of greater than about 60. The blade 12 has a length that extends from a tip 46 to a base or butt 48, and has a top edge surface 50 and a bottom edge surface 52. In an example, at least a portion of the bottom edge surface 52 is a sharpened cutting surface. In an example, the cutting surfaces may be formed by grinding on each opposed side of the blade 12, e.g., providing a Drop Point Blade by grinding on both sides using a flat grinding method. The thickness of the blade as measured along the thickest region of the blade, e.g., adjacent a region of the blade where the main pin 32 extends therethrough may have a thickness of about 3.35 mm in a particular embodiment. The surface of the blade may be coated or otherwise treated to provide a desired finish and/or texture and/or protective barrier for a variety of different purposes depending on the particular end-use applications. In an example, the blade is treated to have a black oxide coating to provide a desired degree of corrosion resistance. Again, the blade is but one example configuration of the folding assembly first member or tool provided for reference, and many other tool configurations are understood to be within the scope of the concept disclosed herein.

The thumb stud 16 is disposed in an opening 54 through the blade 12 adjacent the top edge 50 at a location along the blade length making it practical for a user to contact with their thumb and/or finger to open and close the blade. In an example the thumb stud 16 is secured to the blade though a fastened attachment such as a screwed attachment with a nut.

The blade butt 48 includes a section that is configured to make contact with a stop element or pin 56 that is interposed between the liners 20 and 22, and that forms part of the locking mechanism. In an example, the stop element 56 is secured in place with relative to the liners through the placement of outer ends of the stop element within respective openings 58 and 60 through the liners. The stop element is formed from a metallic material, and in an example is formed from hardened steel having an HRC of greater than about 50, and about 58 to 60. The blade butt section contacts the stop element 56 to thereby limit the upward movement of the blade 12 in an open position, which coincides with a locked open position provided by the locking mechanism. The blade butt 48 further includes a recessed section 62 to enable the blade to be rotated from an open to closed position and vise versa without contacting the stop element 56.

An outer edge of the blade butt 48 in a particularly preferred embodiment is not generally transverse or perpendicular to a longitudinal axis of the blade 12. Instead, the far end of the blade 12 from the tip 46 forming the blade butt 48 is slightly angled, such as at a 5° angle which forms a back stop that engages the stop element 56 and forms a tight fit without any wiggle or movement of the blade 12 when the blade is fully opened, as illustrated in FIG. 1. This may result in the blade 12 being fully extended at slightly less or slightly more than 180°, and instead being extended between 175° and 185°. The inventors have found that forming the butt edge 48 at a 90° perpendicular angle will create wiggle or movement when the blade is fully opened, and thus the invention incorporates a slight angle into the face of the butt 48, as described above.

The blade 12 includes an elongate opening or slot 64 extending therethrough running in a longitudinal direction parallel with an axis running from the butt 48 toward the tip 46. The elongate slot opening 64 is adjacent the butt 48 and is configured to accommodate a locking pin 66 therein that is part of the locking mechanism, and to permit movement of the pin 66 longitudinally within the opening so as to enable the pin 66 to provide release and locking operation (as explained in greater detail below). The blade 12 further includes a recessed groove 68 that is configured to enable the blade 12 to be placed in a closed position within the handle 14 clear of contacting the stop element 56.

The liners 20 and 22 are each provided in the form of a flat plate made from a structurally rigid material, such as a metallic material. In an example, the liners are formed from a stainless steel having an HRC greater than about 50. In an example, the liners are formed from 410, 420 or 40A stainless steel having an HRC of about 50-58, and have a thickness of about 1.02 mm in a particular example. The thickness may be greater or less depending on the load factor imposed thereon by the first member or blade, so as to provide a desired shear force resistance to so as to ensure a robust locking mechanism. In an example, the blade 12 is connected with the liners 20 and 22 so that the liners enclose a desired length of the blade adjacent to the butt end of the blade, which may be referred to as the hub, when placed in an open position that is at least 15 percent, from about 20 to 45 percent, from about 25 to 35 percent, and in an example approximately 30 percent of the total blade length.

The liners 20 and 22 each comprise a channel opening forming a track 70 that is disposed around an outside perimeter of the main opening 18, and that are configured as part of the release and locking mechanisms. In an example, each of the tracks 70 are configured, moving from a rear of the liner to the front, having a first locked region 72 that is elongate extending from a closed end along an axis parallel with a length of the liner. The first locked region 72 extends to a second intermediate section 74 configured in the form of an arc defined by a radius of curvature from the main opening 18. In an example, the intermediate section 74 forms a segment of a circle sufficient to facilitate travel of the locking pin 66 therein during pivoting rotation of the blade 12 between an open and closed position relative to the liners. In an example, the intermediate section 74 comprises between about 90 to 240 degrees of a circle, between about 110 to 200 degrees of a circle, and approximately 180 degrees in a particular application. The intermediate section 74 extends to a second locked region 76 of the track 70 that is elongate extending toward the front of the liners from the second section 74 to a closed end. In an example, the tracks 70 have a width sufficient to accommodate sliding travel of the locking pin 66 therein.

In an example, the first locked region 72 of the track 70 operates to accommodate placement of the locking pin 66 therein to place the blade 12 in a locked open position, wherein the pin 66 is positioned within the first locked region 72 adjacent the close end thereof. In this manner, the tool 12 is fixed in a locked open position by the locking mechanism. For purposes of ensuring engagement, guidance and placement of the locking pin 66 in the first locked region 72 such first locked region 72 may be configured having a tapered width at the transition with section 74, wherein the width at such transition is greater than the width approaching the closed end. In an example, the taper angle can be from about 1 to 10 degrees, 2 to 8 degrees, and in an example approximately 5 degrees. The length of the first locked region 72 is sufficient to capture the entire diameter of the locking pin 66 therein. In an example, the first locked region 72 may have a length that is from about 100 to 300 percent, about 110 to 200 percent, in an example approximately 125 percent of the locking pin 66 diameter.

The fit of the locking pin 66 within the channel opening first locked region 72 is desired to enable a user to unlock the blade 12 from an open position by sliding the locking pin 66 forward by finger, e.g., thumb, contact and activation of slide 38. A spring 78 is disposed within the blade member elongate opening slot 64 and operates to impose a spring force on the locking pin 66 biasing it towards the butt 48 (as best illustrated in FIG. 7). If desired, a guide pin 80 may be placed within the spring 78 so as to maintain desired alignment, and minimize any spring deflection, in the elongate opening slot 64.

In an example, the second locked region 76 operates to accommodate at least partial placement of the locking pin 66 therein when the blade 12 is placed into a closed position. Because the folding knife is one where the blade is at least partially manually moved/pivoted from a closed to an open position, e.g., by a user moving the blade by thumb contact with the stud 16, it is desired that the second locked region 76 be configured in a manner to enable the locking pin 66 to move outwardly therefrom without directly contacting the locking pin 66, as the pin 66 is covered by the grip 24 when the blade 12 is moved from the locked position. In an example, the second locked region 76 may have a length that is less than the diameter of the locking pin 66 and/or be configured having a tapered width that enables registration and easy inward and outward movement of the locking pin 66 therefrom. Thus, the locking mechanism configured as disclosed herein provides both a locked open placement of the blade 12 relative to the handle 14, that must be released by user engagement and activation of the locking pin 66, and a closed placement of the blade 12 that may be released by user movement of the blade.

Washers 82 are interposed between the blade 12 and each of the liners 20 and 22 around the blade main opening 18 to accommodate passage of the main pin 32, 34 therethrough. In an example, the washers may be made from a polymeric and/or metallic material, and may operate to provide eased rotational movement of the blade 12 relative to the liners 20 and 22. In an example, the washers 82 have a thickness of about 0.63 mm, and are formed from brass or bronze and provide a bearing surface for the blade 12.

The grips 24 and 26 may be formed from a structurally rigid material. Suitable materials include wood, polymeric materials, composite materials, metallic materials, and combinations thereof. In an example, the grips 24 and 26 are formed from a hard polymeric material such as composite epoxy-fiber material. The outside surface of the grips 24 and 26 may be smooth or textured. In an example, the grips 24 and 26 have a textured outer surface.

Each of the grips 24 and 26 has, along an inside surface adjacent a respective liner 20 and 22, a recessed channel forming a track 84 that is configured similar to the track 70 in an adjacent liner. The recessed channel tracks 84 thus comprise corresponding first locked region, intermediate track region, and second locked region spaced apart from the first locked region as disclosed above for the liner channel tracks, and are provided to accommodate movement of either the locking pin 66 therein, or movement of a mating end or cap 86 therein that may be threaded or otherwise attached to an end of the pin 66. The recessed channel tracks 84 are sized to accommodate movement of the locking pin 66 head 88 therein in grip 24, and the movement of the locking pin cap 86 therein in grip 26 when the blade 12 is moved between open and closed positions. Generally, the tracks 84 are sized having a larger width than the tracks 70 in the liner to accommodate movement of the pin 66 head 88 and cap 86 therein, which are larger in diameter than the pin 66 shaft 90 that is placed within the liner tracks 70. It is to be understood, however, that the tracks 70 formed in the liners 20 and 22 and the tracks 84 formed in the grips 24 and 26 cooperatively form a track formed in the handle 14 of the folding assembly in which the locking pin 66 moves between first and second locked regions as the blade 12 is moved between closed and open positions.

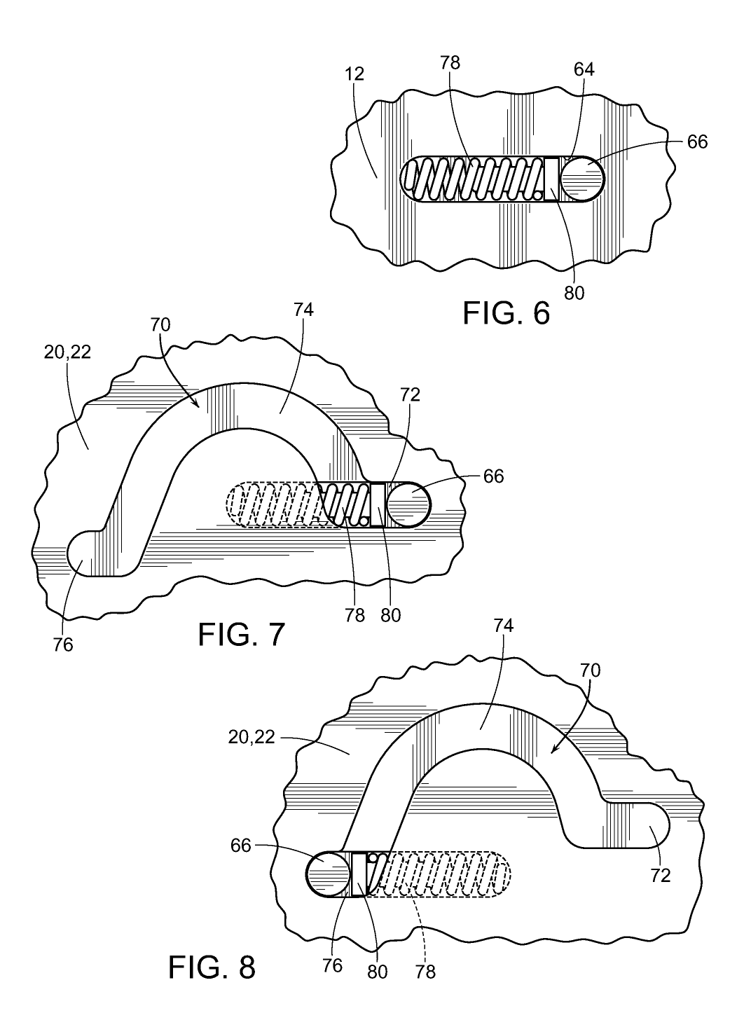

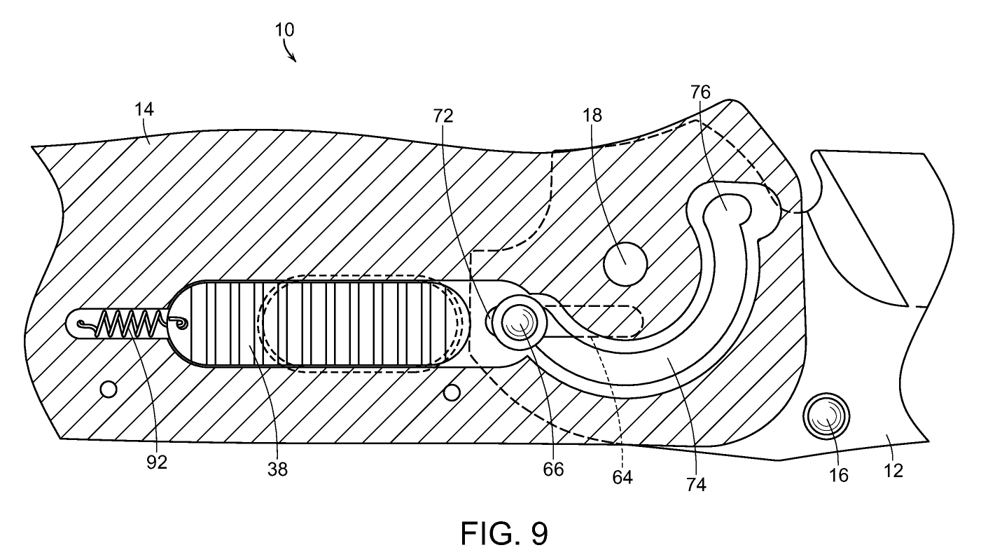

FIG. 6 illustrates the locking pin 66 disposed within the elongated slot 64 of the blade 12 with the spring 78 biasing guide pin 80 into contact with the locking pin 66, typically the shaft 90 of the locking pin 66, towards the butt 48 end of the blade 12, as described above. FIGS. 7 and 8 illustrate the position of locking mechanism components when the blade 12 is in different positions, e.g., an open position and a closed position. Specifically, illustrated are the positions of the locking pin 66 within the track 70 of the liners 20 and 22 when the blade 12 is in an open locked position (FIG. 7) and in a closed position (FIG. 8). Specifically, FIG. 7 illustrates the position of the locking pin 66 within the track 70 of the liners 20 and 22 as being biased by the spring 78 disposed in the blade elongated opening 64 against a closed end of the first locked region 72, thereby operating to lock placement of the blade 12 in an open position. In this position the stop element 56 further acts in conjunction with the locking pin 66, by making contact with a portion of the butt 48 to thereby limit further upward open movement of the blade 12. FIG. 8 illustrates the position of the locking pin 66 within the track 70 of the liners 20 and 22 when locking pin 66 is manually actuated to overcome the spring bias and displace the pin 66 from the first locked region 72, causing the pin 66 to travel along the second section 74 with the blade 12 as the blade is rotated/pivoted counterclockwise relative to the liners 20 and 22 into a closed position where the locking pin 66 is biased by the spring 78 into releasable engagement with the second locked region 76. In this manner, the locking mechanism operates to ensure locked engagement of the blade 12 in an open position, and provide releasable registered engagement of the blade 12 in a closed position.

Folding assemblies comprising locking mechanisms as disclosed herein provide an improvement over conventional locking mechanisms as used with folding assemblies in that the locking mechanisms as disclosed herein are specially constructed comprising a locking pin 66 that is in double shear with two opposed metal liners 20 and 22, and further in conjunction with a stop element 56 connected with the liners 20 and 22 that operates to limit the upward opening motion or movement of the first member and blade 12 relative to the second member or handle 14. Such locking mechanism as disclosed herein is not susceptible to the types of lock failures known to occur with folding assemblies, e.g., embodied in the form of folding knives, employing the conventional linerlock gate systems and the lockback rocker systems, thereby providing minimizing or eliminating lock failure to provide safe, reliable and improved folding assembly locking service life.

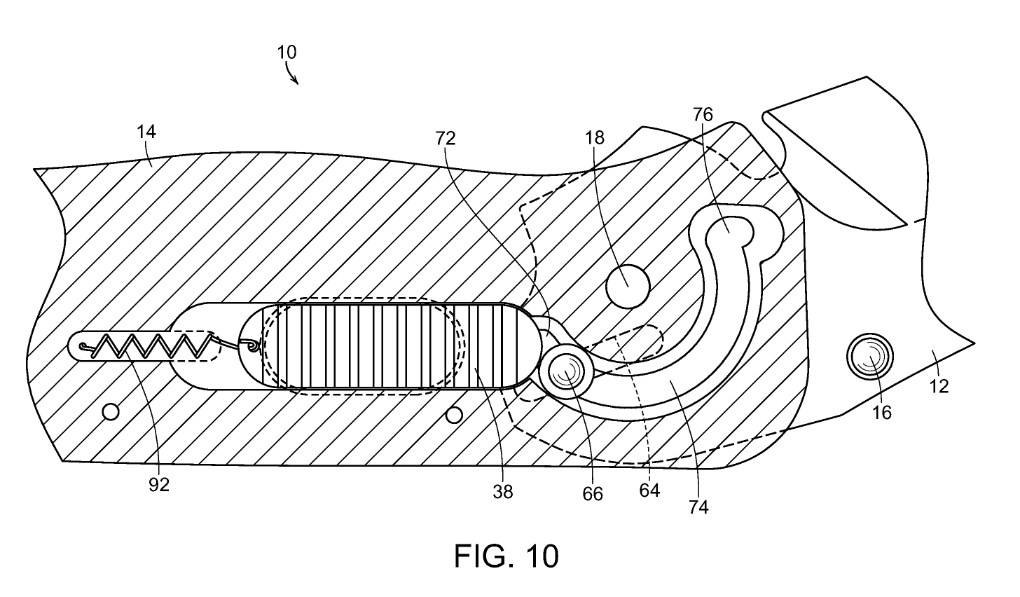

With reference to FIGS. 9 and 10, sectional diagrammatic views are shown of the close-assist mechanism of the folding assembly 10. As mentioned above, a manually actuated slide 38 resides within an open-faced, external recess 36 of a grip of the handle 14 so as to be slidable within the recess 36. A spring 92 is inter connected between the slide 38 and the handle 14, typically grip 24. The spring 92 biases the slide 38 away from the track 70 and locking pin 66, as illustrated in FIG. 9. When the blade 12 is in its open position, as illustrated in FIG. 9, the locking pin 66 is disposed within the first locked region 72 of track 70, as illustrated in FIG. 9. Corresponding placement is illustrated in FIG. 8.

In conventional folding knives, the user would either need to use both hands in order to close blade 12, with one hand grasping the handle 14 in the other blade 12 in order to pivot them towards one another or grasp the handle 14 and apply pressure to the blade 12 against an object, such as a portion of the body of the user, in order to pivot the blade 12 towards the handle 14 and closing the knife. As mentioned above, this presented draw backs in that the blade and/or knife assembly could become damaged or the user injured using the one hand technique.

However, in accordance with the present invention, the user is able to safely close the blade 12 using a single hand to actuate the close-assist mechanism of the present invention. With the blade 12 in the fully opened position, as illustrated in FIG. 9, the user pushes the slide 38, such as with his or her thumb, until it comes into engagement with and moves the locking pin 66 from the first locked region 72 and into the intermediate section 74 of the track, causing the blade 12 to become unlocked and partially move into the closed position, as illustrated in FIG. 10. Preferably, the slide 38 is positioned with respect to the locking pin 66 in the first locked region 72 so that once it is engaged therewith it pushes the locking pin 66 out of its locked position, including the narrower inlet/outlet of the first locked region 72, and into the intermediate section 74 of the track 70. This can be accomplished by the longitudinal axis of the slide 36 being above the center line of the locking pin 66, such that when the slide 38 engages the locking pin 66, it exerts a downward force thereto, similar to a cam action, and dislodges the locking pin 66 from the first locked region 72 of the track 70. It is also preferable that the engaging end of the slide 38 be rounded as illustrated, to facilitate this movement of the locking pin 66. As spring 78 exerts a bias against the locking pin 66 towards the butt end of the blade 12, the locking pin 66, after engagement with slide 38, is moved outwardly and downwardly into the intermediate section of the track 74, causing the blade 12 to partially pivot closed. Once the blade 12 has become unlocked and partially pivoted closed, the use can then easily completely close the blade 12, such as using his or her fingers of the hand holding the handle 14.

As the folding assembly or knife assembly 10 includes an external recess 36 in which the slide 38 moves, there exists the possibility that dirt and other debris can enter into the handle 14. It is also possible that the mere movement of the blade 12 in and out of the handle 14 can allow debris to enter therein. Accordingly, the present invention provides a debris channel 93 in the form of a cut out of one or more of the liners, such as that illustrated formed in liner 20. Debris can accumulate in the debris channel slot 93 and or the debris can be directed from the debris channel 93 and out of the knife assembly, which provides a self-cleaning feature of the assembly 10 that prevents lock up of the blade 12 in either the opened or closed positions.

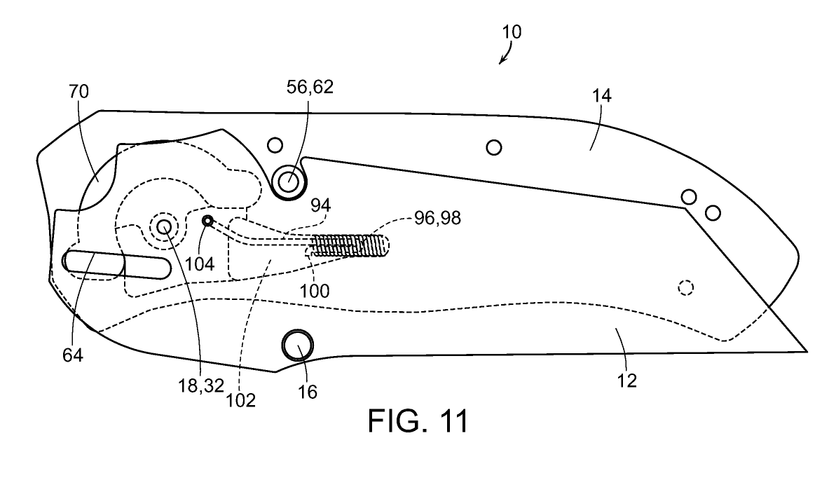

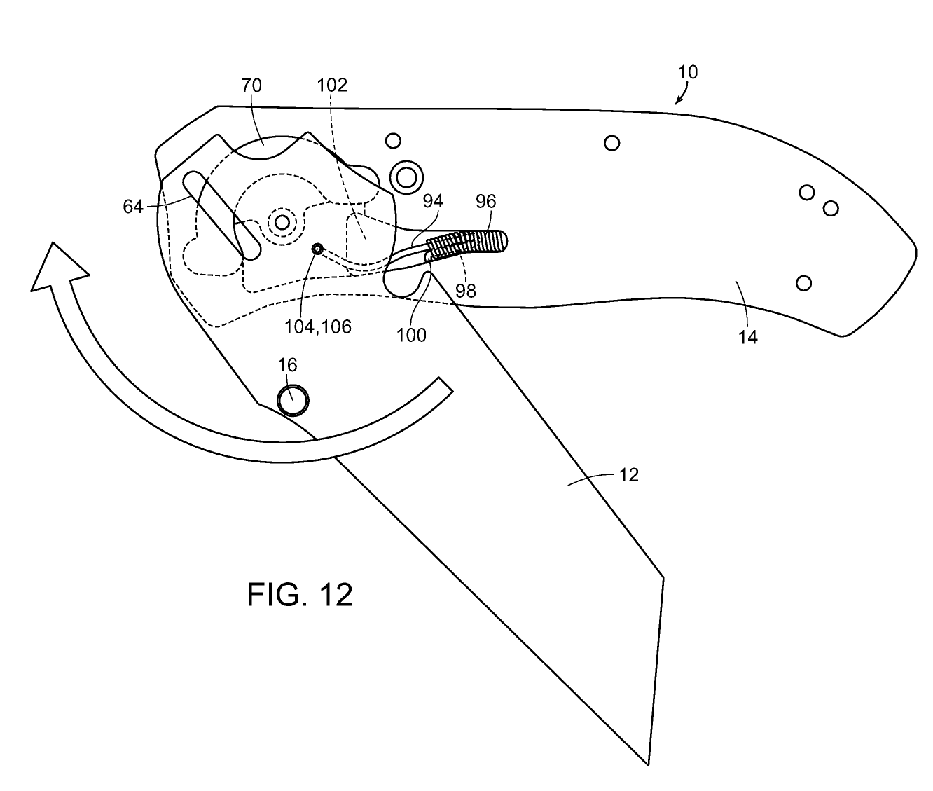

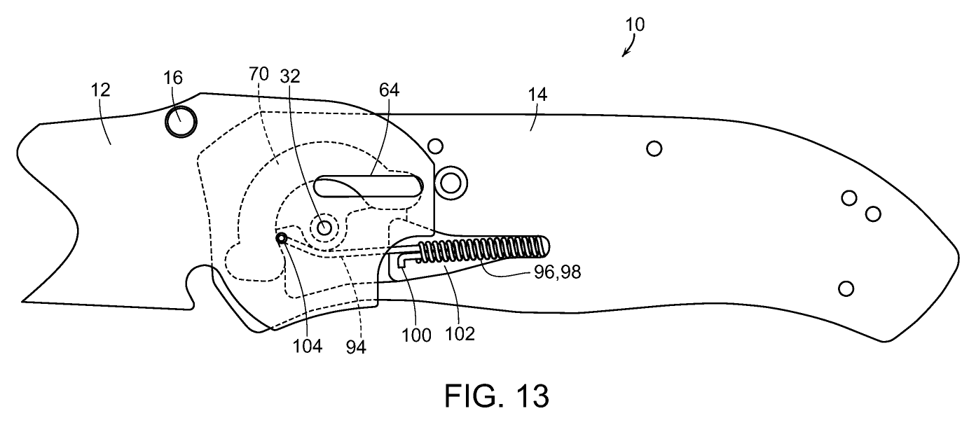

With reference now to FIGS. 11-13, the folding assembly, embodying the form of a folding knife 10, also includes assisted activation of the blade 12 from the closed to the open and locked position. As will be more fully described herein, a spring assist mechanism is employed after the knife blade 12 is partially opened, such as the knife blade 12 being manually opened partially from a closed position, as illustrated in FIG. 11, to a partially open position, such as that illustrated in FIG. 12, wherein the spring assist mechanism of the present invention is activated and the blade 12 is automatically opened over the remaining radial opening pathway until it is into a completely open and locked state, as illustrated in FIG. 13.

This requires that the locking pin 66 be manually moved into the unlocked position after which the blade 12 can be opened. The initial partial opening of the blade 12 from the handle 14 may be completely unassisted and require manual movement by the user thereof or partially assisted movement which assists the user in manually partially opening the knife blade 12 or the spring assist mechanism of the present invention can partially open the blade 12 with a first force and then completely open the blade with a second, and typically larger, force. As such, the knife assembly 10 is not considered a typical or traditional switchblade, which would be completely opened with an assist mechanism having a relatively large force for quickly opening the blade.

In a particularly preferred embodiment, the assist mechanism comprises first and second springs 94 and 96 which act in conjunction with one another in moving the blade 12 to an open position. After the user partially opens the blade 12, such as either pulling outwardly on the blade or more preferably pressing against thumb stud 16, a desired distance or arc, such as approximately 30°, the first spring 94 provides an initial kick-out force of the blade 12 and the second spring 96 provides a continued force thereafter beyond the limited influence of the first spring 94.

With reference to FIGS. 1-5 and 11-13, the first spring 94 is embodied in a wire form spring and the second spring 96 is embodied in a compression spring. A first end 98 of the wire form spring 94 is doubled upon itself and inserted into the compression spring 96, as illustrated in FIGS. 11-13. A free end 100 of the spring acts as a stop to limit the insertion of the bent end 98 and upon which the compression spring 96 acts as it is in engagement therewith.

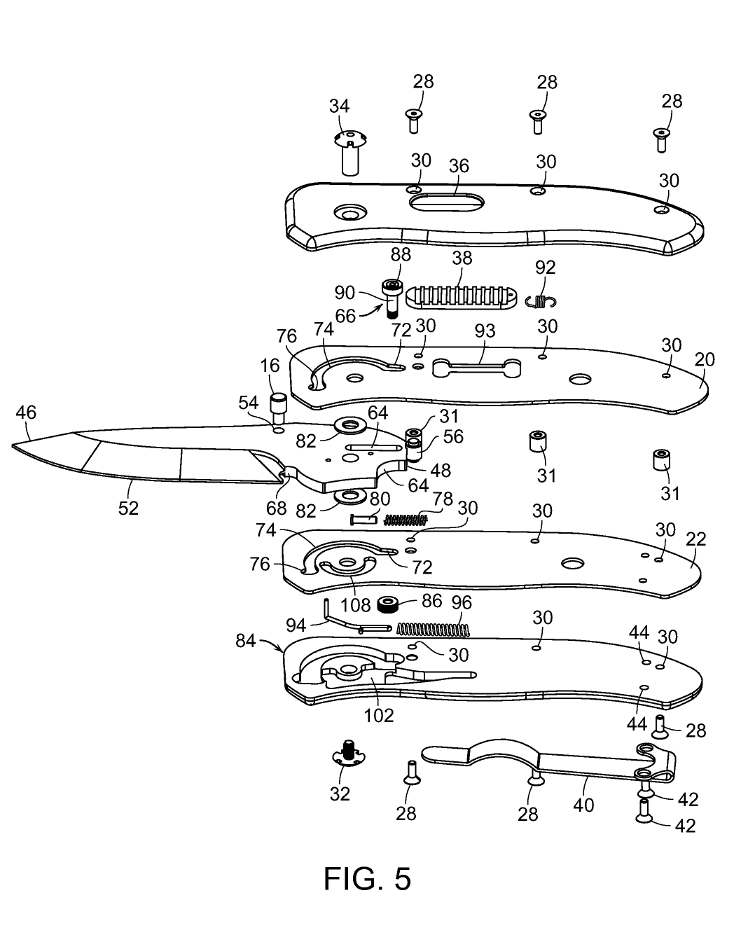

A recess 102 is formed in the handle 14, such as on the inner surface of grip 26, such as illustrated in FIG. 5, into which springs 94 and 96 reside. This recess 102 is disposed adjacent to the track 84, as well as track 70 of the liner 22, such that a free end 104 of the wire formed spring 94, also serving as an idler leg, can be inserted into an aperture or opening 106 formed in the blade 12, generally in the back butt section 48, and typically adjacent to the main pivoting pin 32. A generally circular channel or slot 108 is formed in liner 22 to accommodate the movement of the idler leg end 104 of spring 94 in operation.

When the knife is assembled and the coupled springs 94 and 96 are disposed within the grip recess 102 (they may also be disposed within a recess or opening 110 of the adjacent liner if deemed necessary), and the idler leg end 104 inserted into the blade through opening 106, the springs 94 and 96 are in a tensioned and compressed state when the blade 12 is in the closed position, as illustrated in FIG. 11. As the blade is opened, as illustrated in FIG. 12, over an initial arc and travel of the rotation of the blade 12 (after the blade 12 has been manually opened a predetermined amount, such as up to 30°), the first spring 94 acts to assist the blade opening. This may occur, for example, during the initial 30° to 50° range of travel of the blade 12 from its closed position. Once the blade 12 reaches a predetermined travel range, such as between 30° to 50°, at a given point the first spring's 94 force on the blade 12 will lessen or cease and the compression spring 96 will serve to automatically open the blade 12 over the remaining second range of arc of its rotation and travel, until it is fully open, as illustrated in FIG. 13, wherein the first and second springs 94 and 96 are in a relaxed state of equilibrium or in a neutral state. Typically, the second spring 96 exerts a greater opening force than the first spring 94.

With reference to FIG. 12, when the blade 12 is manually rotated into the closed position, the second compression spring 96 becomes fully compressed as the first wire spring 94 is pushed toward the rear of the knife assembly, causing the stop 100 to press against the compression spring 96. It can be seen in FIGS. 11 and 12 that the wire formed spring 94 will become temporarily bent or otherwise deformed during the closure of the blade 12. This serves to apply tension or compression to both springs 94 and 96, the energy and force thereof will be actuated as the knife blade 12 is opened, as described above, and also more positively locks the blade 12.

The open-assist mechanism of the present invention is considered safer than a fully assisted knife, such as a switchblade or the like, as the initial opening of the blade 12 is assisted with a first force, applied by the first wire formed spring 94, as the user manually opens the knife, and the remainder of the travel and opening of the blade is actuated and applied by the second coil spring 96 under a greater force. Such an arrangement is believed to facilitate the manual opening of the knife assembly 10 while being legal to own and operate by all users, not only military and police personnel.

While folding assemblies comprising locking and open-assist mechanisms as disclosed herein have been described with reference to a particular embodiment in the form of folding knives, it is to be understood that folding assemblies comprising locking mechanisms as disclosed herein are intended to be embodied in folding mechanisms having first and second members, or tool and handle, that may be configured differently as called for by a particular end-use application, which other different configurations are fully intended to be within the scope and spirit of the concepts disclosed herein. Accordingly, it is to be understood that the locking mechanism as disposed herein is intended for with all such alternative folding member end-use embodiments. Other modifications and variations of folding assemblies and locking mechanisms as disclosed herein will be apparent to those skilled in the art.

It is, therefore, to be understood that within the scope of the present disclosure that such folding assemblies and locking mechanisms may be practiced otherwise than as specifically described, and thus although several embodiments have been described in detail for purposes of illustration, various modifications may be made without departing from the scope and spirit of the invention. Accordingly, the invention is not to be limited, except as by the appended claims.

What is claimed is:

1. A folding assembly, comprising:
a handle;
a tool pivotally connected to the handle and movable between a closed position in which the tool extends along the handle and an open position in which a free end of the tool extends away from the handle;
a track formed in the handle radially from a pivotal connection point of the tool and the handle and defining a first locked region;
a locking pin extending axially through an elongated slot formed in the tool and into the track, wherein a portion of the locking pin travels a length of the track as the tool is moved between closed and opened positions; and
a slide disposed within an external recess of the handle and manually movable to engage and move the locking pin from the first locked region of the track, partially moving the tool towards the closed position.

2. The assembly of claim 1, wherein the slide is biased away from the locking pin.

3. The assembly of claim 1, including a spring disposed within the elongated slot of the tool for biasing the locking pin away from the free end of the tool.

4. The assembly of claim 3, wherein the spring comprises a compression spring disposed within the slot generally transverse to the locking pin.

5. The assembly of claim 4, including a guide pin disposed within the slot and the compression spring.

6. The assembly of claim 1, wherein the handle comprises first and second grips and first and second liners disposed between the grips in spaced relation on opposite sides of the tool when in the closed position.

7. The assembly of claim 6, wherein the track is formed in at least one of the first and second grips and at least one of the first and second liners.

8. The assembly of claim 1, wherein the locking pin locks the tool in the open position when in the first locked region of the track, and locks the tool in the closed position when in the second locked region of the track.

9. The assembly of claim 1, including a mechanism for assisting in the opening of the tool comprising at least one spring extending between the tool and the handle which exerts an opening force to the tool once the tool has been manually moved a distance along its opening path.

10. The assembly of claim 9, wherein the assisting mechanism comprises a first spring and a second spring disposed within the handle that cooperatively assist in moving the tool to an open position.

11. The assembly of claim 10, wherein the first spring exerts a first force to the tool and the second spring exerts a second force to the tool which is greater than the first force.

12. The assembly of claim 10, wherein the first spring exerts an opening force along a first range of the opening path of the tool and the second spring exerts an opening force along at least a second range of the opening path of the tool.

13. The assembly of claim 10, wherein the first spring comprises a wire form spring extending between the tool and the handle and a second spring comprising a compression spring which at least partially surrounds the first spring.

14. The assembly of claim 1, wherein the folding assembly comprises a folding knife, and the tool comprises a blade.

15. A folding assembly, comprising:
a handle;
a tool pivotally connected to the handle and movable between a closed position in which the tool extends along the handle and an open position in which a free end of the tool extends away from the handle;
a locking pin extending axially through an elongated slot formed in the tool and into a track of the handle, wherein a portion of the locking pin travels a length of the track as the tool is moved between the closed and open positions; and
a mechanism for assisting in the opening of the tool comprising at least one spring extending between the tool and the handle which exerts an opening force to the tool once the tool has been manually moved a distance along its opening path.

16. The assembly of claim 15, wherein the assisting mechanism comprises a first spring and a second spring disposed within the handle that cooperatively assist in moving the tool to an open position.

17. The assembly of claim 16, wherein the first spring exerts a first force to the tool and the second spring exerts a second force to the tool which is greater than the first force.

18. The assembly of claim 16, wherein the first spring exerts an opening force along a first range of the opening path of the tool and the second spring exerts an opening force along at least a second range of the opening path of the tool.

19. The assembly of claim 16, wherein the first spring comprises a wire form spring extending between the tool and the handle and a second spring comprising a compression spring which at least partially surrounds the first spring.

20. The assembly of claim 15, including a slide disposed within an external recess of the handle and manually movable to engage and move the locking pin from a locked position within the track preventing closing of the tool to an unlocked position within the track and partially moving the tool to the closed position.

21. The assembly of claim 20, wherein the slide is biased away from the locking pin.

22. The assembly of claim 15, including a spring disposed within the elongated slot of the tool for biasing the locking pin away from the free end of the tool.

23. The assembly of claim 22, wherein the spring comprises a compression spring disposed within the slot generally transverse to the locking pin.

24. The assembly of claim 23, including a guide pin disposed within the slot and the compression spring.

25. The assembly of claim 15, wherein the handle comprises first and second grips and first and second liners disposed between the grips in spaced relation on opposite sides of the tool when in the closed position.

26. The assembly of claim 25, wherein the track is formed in at least one of the first and second grips and at least one of the first and second liners.

27. The assembly of claim 15, wherein the track is generally disposed radially from a pivotal connection point of the tool and handle, and defines a first locked region and a second locked region spaced from the first locked region.

28. The assembly of claim 27, wherein the locking pin locks the tool in the open position when in the first locked region of the track, and locks the tool in the closed position when in the second locked region of the track.

29. The assembly of claim 15, wherein the folding assembly comprises a folding knife, and the tool comprises a blade.
